(19) United States
(12) Patent Application Publication
(10) Pub. No.: US 2008/0275784 A1
(43) Pub. Date: Nov. 6, 2008

(54) PROCESSES FOR AUTOMATED DIGITAL DISTRIBUTION OF CONTENT AND PRODUCTS THEREBY

(76) Inventors: Gary Kramer, Los Angeles, CA (US); Adam Rubin, Los Angeles, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 12/113,897

(22) Filed: May 1, 2008

Related U.S. Application Data
(60) Provisional application No. 60/915,285, filed on May 1, 2007.

(51) Int. Cl. G06Q 30/00

(52) U.S. Cl. 705/14

(57) ABSTRACT

The invention provides a system and method for an automated platform that allows for the distribution of digital content (including pictures, audio, video, podcasts, RSS feeds and many others) by means of a digital media player created within branded frames or skins or digital interactive pictures, both types of digital content which allow for enhanced viewing of the digital content and provide integrated and, distributable branding. Revenue can be generated by one of the owner of the digital content, the owner of the digital medium hosting the content and the provider of the automated mechanism.

### CROSS REFERENCE TO RELATED APPLICATION

This filing claims priority of, and full Paris Convention Priority to, U.S. Ser. No. 60/915,285 filed May 1, 2007 by the present inventors, and on behalf of the above listed assignee.

### BACKGROUND OF THE INVENTION

The Virtual Iris automated digital distribution method opens up the entire Internet and mobile arena to branding and advertising, much more akin to the non-electronic world. As companies like Nike or Apple provide free posters or other accessories at their stores that users can then display or give to friends, so does this create a similar opportunity online. Except here, the global spread of imagery, branding, and advertising via the Internet and mobile space could be far greater. In short, longstanding needs to link content providers and posters digitally remain unaddressed prior to the advent of the instant teachings.

### FIELD OF INVENTION

The invention provides a system and method for an automated platform to enhance and distribute digital content along with associated branding and advertising revenue to be generated by multiple different groups in the value chain including potentially the owner of the digital content, the owner of the digital medium hosting the content the provider of the automated mechanism, and at times individual consumers.

### SUMMARY OF THE DISCLOSURE

Briefly stated the disclosure provides a system and method for an automated platform that allows for the distribution of digital content (including pictures, audio, video, podcasts, RSS feeds, and many others) by means of a digital media player created within branded frames or skins or digital interactive pictures, both types of digital content which allow for enhanced viewing of the digital content and provide integrated and, distributable branding. Revenue can be generated by the owner of the digital content, the owner of the digital medium hosting the content and the provider of the automated mechanism.

The disclosure provides a system and method for an automated platform that allows for the distribution of digital content (including pictures, audio, video, podcasts, RSS feeds, and many others) by means of a digital media player created within branded frames or skins or digital interactive pictures, both types of digital content which allow for enhanced viewing of the digital content and provide integrated and, distributable branding. Revenue can be generated by the owner of the digital content, the owner of the digital medium hosting the content and the provider of the automated mechanism.

Individual publishers of digital content can create their own media players and interactive pictures by means of the automated platform and create their own branded media player frames or skins. Once the player of digital content or interactive pictures has been created, users can then share or send their digital content along with branding and advertising from websites or places where the media player or digital pictures have been placed. The media players and interactive pictures, connected to the branding and advertising can then be placed in Internet web pages, emails, mobile devices, and most other devices that display digital content.

Media players or interactive pictures can also be created by users themselves, using their own content, either directly via links from another media player, a website, a blog, or any other digital space. Users can then use branded skins for specific companies, organizations, or generic skins, to send out digital content, along with which advertising can be served.

Overall, this “branded community” concept allows for the creation of a platform incorporating interactivity with digital content with community aspects such as having your own account, sharing, rating, emailing, sms'ing, and the ability to brand and serve content for specific companies and organizations.

The invention allows for a new method of branding and advertising by providing for digital content to be distributed virally in new ways. The disclosure allows for a method of advertising that moves beyond the current model of advertising that is tied to digital content being displayed on a single digital medium hosting the content. The disclosure will allow for advertising revenue to be generated by the owner of the digital content, the owner of the digital medium hosting the content and the provider of the automated mechanism.

According to embodiments, there is provided a process for facilitating automated digital distribution, comprising in combination, driving viral distributions of digital content, enabling branding to designate respective sources of origin of at least one goods and services, advertising desired content upon a single platform, and generating revenues by way of at least one of those entities selected from the group consisting of owners of digital content and owners of the digital medium, hosting the content, providers of the automated mechanisms, and consumers, whereby branded communities are established.

According to embodiments there is provided a branded community platform incorporating interactivity with digital content and community attributes further comprising individual account identity, sharing, rating, emailing, sms'ing, branding and serving content for specified companies and organizations.

### BRIEF DESCRIPTION OF THE FIGURES

FIG. 1 schematically depicts the steps of a process according to embodiments of the present invention.

### DETAILED DESCRIPTION OF THE DISCLOSURE

Briefly stated, the invention provides a system and method for an automated platform that allows for the distribution of digital content (including pictures, audio, video, podcasts, RSS feeds and many others) by means of a digital media player created within branded frames or skins or digital interactive pictures, both types of digital content which allow for enhanced viewing of the digital content and provide integrated and, distributable branding. Revenue can be generated by the owner of the digital content, the owner of the digital medium hosting the content and the provider of the automated mechanism.

According to an embodiment of the invention there is provided a method enabling viral distribution of digital content, branding, and advertising via a single platform, generating revenues for the at least one of the owners of digital content, owners of the digital medium hosting the content, provider of the automated mechanism, and consumers to generate revenues and establish branded communities. In combination, the steps of distributing digital content by way of an automated platform to distribute digital content with branding allows for enhanced viewing, enhancing the digital content, embedding advertising or branding information within the automated mechanism, generating revenue from the owner of the digital content, the owner of the digital medium hosting the content and the provider of the automated mechanism, and creating a community of users with the ability to have their own account, share, rate, email, and sms digital content as well as potentially generate revenues.

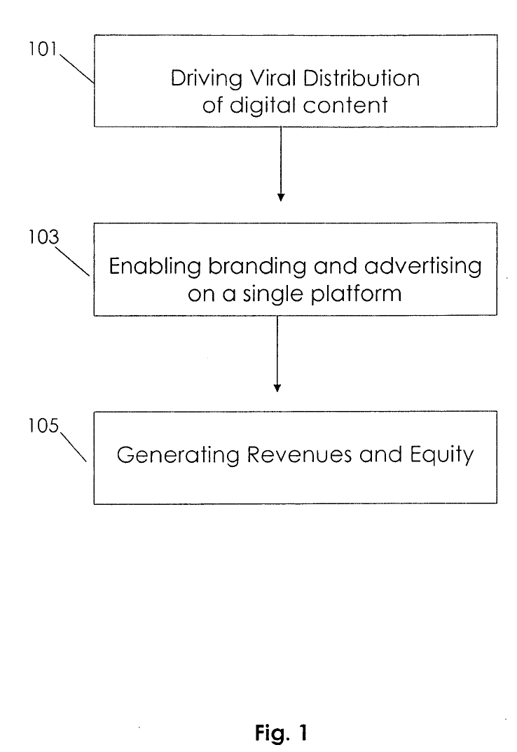

Referring now to FIG. 1, as described throughout and claimed below, step 101 involves driving viral distribution of digital content. This is facilitated by step 103, enabling branding and advertising to be arrayed simultaneously on a single platform. Step 105 adds the revenue generating model and equity creation for the digital community. Those skilled in the art understand that the teachings of U.S. Pat. No. 7,7267,783 expressly incorporated herein by reference, enable use of this automated platform and shall readily realize how the instant filing compliments use of the same.

The present inventors, Virtual Iris Studios, Inc., (11692 Darlington Avenue, PH2, Los Angeles, Calif.) have developed a system for enabling Internet publishers, Advertising networks, and consumers to all generate additional revenues through a new process based around the Virtual Iris software platform. This new method is based on the ability for digital imagery, branding, and advertising to be spread across the Internet and mobile space from individual websites, blogs, or emails. The concept combines multiple facets, included the ability to integrate companies and websites with their user communities, in a sense creating “branded communities”. Brands and online communities exist today, but via the Virtual Iris platform, they can be integrated and monetized.

Entities or individuals create a digital media player (which could include pictures, video, music, or other digital media) or interactive pictures, display them on their websites, blogs, or emails, and allow visitors to their site, blog, or email to share the media and Interactive pictures or send them in email. Branding in different forms, such as a digital picture frame, can be created and distributed along with the images. Banner advertising can also be distributed with the digital media. As the media, branding, and advertising are disseminated by users across the Web, all of it can be updated at any moment. As a result, digital media can be globally changed, branding can be adjusted, and advertising banners can be rotated and updated, creating dynamic electronic billboards across the Web. The net result is that Web publishers can now make more money from the display of their advertising in far more places, Advertisers now have much greater access to a wider marketplace, and consumers can access more imagery and display it in more places than ever before. Also, by facilitating “branded communities” of users, such as Los Angeles Dodgers fans, the ability to promote within a targeted audience becomes much greater.

What makes this method so novel is that never before has there been a way to “virally” spread digital media, branding, and advertising, so easily and affordably. Before this method, websites, blogs, or emails were a finite universe in terms of the branding and advertising opportunities possible. Websites, for example, could only derive revenues from the advertisers that paid fees based on impressions or click-throughs on each specific site. The user base that could be targeted was also finite, as only those users coming to a particular site, blog, or email could see displayed imagery, branding, or advertising. This method changes all that. Media displayed on a website, blog, or email, can be shared, via code that can be copied anywhere, such as in a MySpace.com account or a Blogger.com blog, or emailed anywhere.

The media, branding, and advertising can also be displayed directly inside an email, unlike most interactive imagery today. It can also be displayed on mobile devices. Any media, branding, or advertising on a website, if displayed using this new method can now be copied, emailed, or sms/mms'ed anywhere. As a result, the entire Internet and mobile space becomes an accessible forum in terms of branding or advertising access for any online entity, and as its website, blog, or email users are actually spreading its content, branding, and advertising, this added exposure and revenue potential is all added without substantial cost. Publishers make more money as their advertising is disseminated and displayed in many places, while networks make more money by serving more advertising.

In addition, the content itself can be created in different ways. Individual publishers can create their own galleries and interactive pictures. This is an automated mechanism provided by the Virtual Iris platform, and also allows for the creation of branded gallery frames or skins. Another alternative is that publishers can offer visitors to the site or blog the ability to create their own customized galleries or interactive pictures. The same method then applies either way.

Once the gallery or interactive picture has been created, users can then share or send their pictures along with branding and advertising which is attached in some fashion. The advantages are numerous, with one primary one being that as most websites are not mobile-enabled, the media player, for example, can be used as a type of mini-site, where an abbreviated version of the sites media can be displayed and shared on cellular phones.

Another feature of the Virtual Iris improved process is the potential ability for consumers to make money from the expanded advertising serving capability. Using an online creation gallery or interactive picture creation mechanism, such as can be found on the website Irisize.com, users create galleries or interactive pictures, and the more they send them out, the more advertising is displayed. As a result, consumers can receive a percentage of the advertising revenue generated based on the number of times their gallery or interactive picture is displayed or clicked through. A win-win for everyone along the food chain.

Overall, the new Virtual Iris process so pens up the entire Internet and mobile arena to branding and advertising, much more akin to the non-electronic world. As companies like Nike or Apple provide free posters or other accessories at their stores that users can then display or give to friends, so does this create a similar opportunity online. Except here, the global spread of imagery, branding, and advertising via the Internet and mobile space could be far greater.

It should also be understood that a variety of changes may be made without departing from the essence of the invention. Such changes are also implicitly included in the description. They still fall within the scope of this invention. It should be understood that this disclosure is intended to yield a patent covering numerous aspects of the invention both independently and as an overall system and in both method and apparatus modes.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these.

Particularly, it should be understood that as the disclosure relates to elements of the invention, the words for each element may be expressed by equivalent apparatus terms or method terms—even if only the function or result is the same.

Such equivalent, broader, or even more generic terms should be considered to be encompassed in the description of each element or action. Such terms can be substituted where desired to make explicit the implicitly broad coverage to which this invention is entitled.

It should be understood that all actions may be expressed as a means for taking that action or as an element which causes that action.

Similarly, each physical element disclosed should be understood to encompass a disclosure of the action which that physical element facilitates.

Any patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in at least one of a standard technical dictionary recognized by artisans and the Random House Webster's Unabridged Dictionary, latest edition are hereby incorporated by reference.

Finally, all referenced listed in the Information Disclosure Statement or other information statement filed with the application are hereby appended and hereby incorporated by reference; however, as to each of the above, to the extent that such information or statements incorporated by reference might be considered inconsistent with the patenting of this/these invention(s), such statements are expressly not to be considered as made by the applicant(s).

In this regard it should be understood that for practical reasons and so as to avoid adding potentially hundreds of claims, the applicant has presented claims with initial dependencies only.

Support should be understood to exist to the degree required under new matter laws—including but not limited to United States Patent Law 35 USC 132 or other such laws—to permit the addition of any of the various dependencies or other elements presented under one independent claim or concept as dependencies or elements under any other independent claim or concept.

To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, the use of the transitional phrase “comprising” is used to maintain the “open-end” claims herein, according to traditional claim interpretation. Thus, unless the context requires otherwise, it should be understood that the term “compromise” or variations such as “comprises” or “comprising”, are intended to imply the inclusion of a stated element or step or group of elements or steps but not the exclusion of any other element or step or group of elements or steps.

Such terms should be interpreted in their most expansive forms so as to afford the applicant the broadest coverage legally permissible.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A process for facilitating automated digital distribution, comprising, in combination:
driving viral distributions of digital content;
enabling branding to designate respective sources of origin of at least one of goods and services;
advertising desired content upon a single platform; and,
generating revenues by way of at least one of those entities selected from the group consisting of owners of digital content, owners of the digital medium hosting the content, providers of the automated mechanisms, and consumers;
whereby branded communities are established.

2. The process of claim 1, wherein the driving step further comprises:
distributing digital content by way of an automated platform to distribute digital content whereby branding enables enhanced viewing in at least one format selected from the group of branded skins, frames and digital interactive pictures.

3. The process of claim 2, further comprising enhancing the digital content.

4. The process of claim 3, further comprising embedded advertising information within the automated platform.

5. The process of claim 4, further comprising embedding branding information within the automated platform.

6. The process of claim 5, whereby equity is created by generating revenue from the owner of the digital content, and a portion is contributed to a branded community.

7. The process of claim 5, whereby equity is created by generating revenues from the owner of the digital media hosting the content, and a portion is contributed to the branded community.

8. The process of claim 5, whereby equity is created by generating revenue from the provider of the automated platform, and a portion is contributed to the branded community.

9. A product by the process of claim 6, further comprising a community of users.

10. A product by the process of claim 7, further comprising a community of users.

11. A product by the process of claim 8, further comprising a community of users.

12. A branded community platform incorporating interactivity with digital content and community attributes further comprises individual account identity, sharing, rating, emailing, sms'ing, branding and serving content for specified companies and organizations.

13. The branded community platform as defined in claim 12, said digital content being at least one of pictures, audio, video, podcasts, RSS feeds and related species of content.
